(19) United States
(12) Patent Application Publication
(10) Pub. No.: US 2020/0140590 A1
(43) Pub. Date: May 7, 2020

(54) RESIN FOR UNIVERSAL SOLVENTBORNE PIGMENT DISPERSION

(71) Applicant: SWIMC LLC, Cleveland, OH (US)

(72) Inventors: Michael D. Coad, Frankfort, IL (US); Aaron M. Palmer, Saint Anne, IL (US); Catrina A. Shumpert, Country Club Hills, IL (US); Peggy L. Steffy, Hammond, IN (US); Philip J. Ruhoff, Shaker Heights, OH (US); Syed Y. Hasan, Strongsville, OH (US); Timothy B. Kiger, Sagamore Hills, OH (US)

(73) Assignee: SWIMC LLC, Cleveland, OH (US)

(21) Appl. No.: 16/607,559

(22) PCT Filed: Feb. 8, 2018
(86) PCT No.: PCT/US2018/017356

§ 371 Date: Oct. 23, 2019

Related U.S. Application Data
(63) Continuation of application No. 15/494,609, filed on Apr. 24, 2017, now abandoned.

(51) Int. Cl. C08F 220/18; C09D 7/63; C08K 5/00; C09D 133/06; C09D 133/10; C09D 17/00; C09B 67/46

(52) U.S. Cl. CPC C08F 220/18; C09D 7/63; C08K 5/0091; C09D 7/65; C09D 133/10; C09D 17/002; C09B 67/009; C09D 133/062

(57) ABSTRACT

A copolymeric pigment dispersion resin derived from isobornyl (meth)acrylate and one or more other monomers has a number average molecular weight less than about 10,000 and is derived from sufficient isobornyl (meth)acrylate so that a 60 wt. % solution of the resin in propylene glycol monomethyl ether acetate forms a clear solution when combined at room temperature with at least three times the resin weight of odorless mineral spirits. The resin may be compatibly mixed with solvent-borne coating compositions based on polar or on non-polar solvents, and can provide a single factory shader or point-of sale colorant formulation for tinting a wide range of such coating compositions.

### TECHNICAL FIELD

The present disclosure relates to pigment dispersion resins for use in making or tinting paints and other coating compositions.

### BACKGROUND

Coating compositions may include color imparted by pigment particles. The pigment may be added in a coating composition manufacturing facility, where large batches (e.g., typically 50 liters or more) may be manufactured in one or a few standard premixed colors. Colorants containing pigments may also be added to one or more base coating compositions at point-of-sale outlets using volumetric colorant dispensing and shaker mixing equipment to make small batch lots (e.g., typically less than 50 liters) of custom-tinted coating compositions in a much larger array of colors than the limited color array available in premixed products.

Years ago, colored coating compositions were virtually all solvent-borne. Nowadays a significant proportion of such materials are water-borne. However, many solvent-borne coating compositions are required or preferred in some end-use applications, and may continue to be required or preferred well into the future.

In the retail paint business, so-called “universal colorants” have been developed for use in point-of-sale tinting equipment. These point-of-sale universal colorants typically are formulated by modifying a water-borne colorant formulation to include appropriate surfactants, and optionally to include appropriate dispersing agents or cosolvents, so that the colorant can tint either a water-borne or solvent-borne base paint or stain using the same tinting machine.

### SUMMARY

The above-mentioned point-of sale universal colorants normally are added to only a few varieties of solvent-borne coating compositions (e.g., medium oil alkyds, long oil alkyds, and oil-based stains, and typically intended for architectural or consumer use in coating or staining wood). Such point-of sale universal colorants are however primarily used to tint waterborne coating compositions such as latex paints. Because latex paints typically represent over 80% of the total paint volume supplied by a retail paint store, universal colorants are normally formulated to optimize their performance in such waterborne systems. The performance of point-of-sale universal colorants in solvent-based systems may be somewhat suboptimal, and may for example be provide poorer pigment dispersion or poorer tinted film performance than specialized point-of-sale colorants intended only for use with solvent-based systems.

Coating composition manufacturers typically make a variety of other solvent-borne coating compositions that may have poor or no compatibility with such point-of sale universal colorants. Such other solvent-borne coating compositions may for example include industrial metal coatings such as epoxies, urethanes and short oil alkyds (which typically include a non-aqueous carrier liquid having a polar character), and compositions intended for the industrial coating or staining of wood such as medium and long oil industrial alkyds and stains (which typically include a carrier liquid having a non-polar character, such as odorless mineral spirits). Whether mixed with pigments in a manufacturing facility or at a point-of sale location, these other solvent-borne coating compositions normally are colored or tinted using individually-formulated pigment dispersions whose composition may vary depending on the chosen binder, the carrier liquid and in some cases even the desired final color. For example, when preparing many pigmented solvent-based coating compositions, pigment particles typically are blended with a dispersion resin dissolved in a solvent, to make a pigment vehicle. The pigment vehicle is then blended with a binder, a carrier liquid, and other components to form the desired coating composition. The dispersion resin generally must be compatible with the carrier liquid. When preparing a coating composition using odorless mineral spirits as the carrier liquid, it may for example be necessary to use a pigment vehicle containing a different dispersion resin than the pigment dispersion resin that would be used with coating compositions containing a polar carrier liquid.

Many known acrylic-based dispersion resins are soluble in solvents such as water, ketones, acetates, or aromatics, but are insoluble or have limited solubility in mineral spirits. For example, commercial dispersion resins such as PARALOID™ DM-55 from Dow Chemical Company, LAROPAL™ A 81 from BASF Corporation and Dianal TB-219 from Dianal America, Inc., each are soluble in certain conventional solvents but have limited solubility in odorless mineral spirits (CAS No. 68551-17-7). The extent to which a dispersion resin is soluble in odorless mineral spirits appears to provide a useful indicator of the compatibility of such dispersion resin with a variety of different polymer or resin systems, and its consequent effectiveness or flexibility in dispersing pigments across a range of such systems.

It would be desirable to provide a pigment dispersion resin that is compatible both with polar carrier liquids and with mineral spirits. Such a pigment dispersion resin would enable a coating composition manufacturer (e.g., a paint manufacturer) to use the same pigment dispersion resin in multiple types of solvent-borne coating compositions, including coating compositions having polar carrier liquids and coating compositions having nonpolar carrier liquids. This could simplify in-plant production processes for such manufacturers, and could also provide more flexible or more capable point-of-sale colorant arrays for tinting solvent-borne coating compositions at retail locations. The resulting pigment dispersion resins could be called “universal solvent-borne pigment dispersion resins”, and are believed to represent a new product category. It should be borne in mind that such dispersion resins represent a different end-use and different product than the point-of sale universal colorants discussed above, as they are not required to perform well in waterborne systems.

The present invention provides, in one aspect, a pigment dispersion resin comprising a copolymer including monomer units derived from isobornyl (meth)acrylate and one or more other monomers, wherein the copolymer has a number average molecular weight (Mn) less than about 10,000 and is derived from sufficient isobornyl (meth)acrylate so that a 60 wt. % solution of the copolymer in propylene glycol monomethyl ether acetate (“PM Acetate”, CH₃CO₂CH(CH₃)CH₂OCH₃, CAS No. 108-65-6) forms a clear solution when combined at room temperature with at least three times the copolymer weight of odorless mineral spirits.

The disclosed copolymer has substantial or complete solubility both in polar solvents (e.g., ketones, acetates and polar aromatic liquids) and in nonpolar solvents (e.g., odorless mineral spirits). While it is not intended to limit the invention to a particular theory of operation, we believe that different aspects or domains of the disclosed copolymers may provide the pigment dispersion resin with both polar and non-polar characteristics that facilitate dissolution of the copolymer in a wide range of polar and nonpolar solvents. Such aspects or domains may be provided at least in part by the recited isobornyl (meth)acrylate methacrylate monomers, viz., by isobornyl acrylate (IBA) or isobornyl methacrylate (IBMA), which respectively have structures I and II shown below:

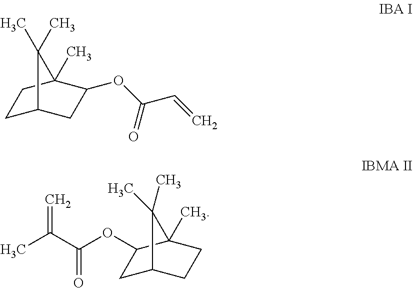

The invention provides, in another aspect, a pigment vehicle for in-plant use or a colorant for point-of-sale use, the pigment vehicle or colorant comprising a dispersion of one or more pigments in the above-described copolymer and an optional polar or nonpolar nonaqueous solvent.

The invention provides, in yet another aspect, a coating composition comprising a dispersion of one or more pigments in a solution or dispersion containing the above-described copolymer, a film-forming binder resin and a polar or nonpolar nonaqueous solvent.

The invention provides, in a further aspect, a point of sale system comprising a plurality of base coating compositions and a compatible array of colorants, the coating compositions including at least one coating composition comprising a film-forming binder resin and a polar nonaqueous solvent and at least one coating composition comprising a film-forming binder resin and a nonpolar solvent, and the array of colorants including at least white, black, red, blue and green colorants containing pigment, the above-described copolymer and an optional polar or nonpolar nonaqueous solvent.

The invention provides, in a further aspect, a point of sale method for tinting coating compositions, comprising the step of using an array of colorants each containing pigment, a copolymer and an optional polar or nonpolar nonaqueous solvent to tint a plurality of base coating compositions including at least one coating composition comprising a film-forming binder resin and a polar nonaqueous solvent and at least one coating composition comprising a film-forming binder resin and a nonpolar solvent, wherein the array includes at least white, black, red, blue and green colorants each of which contains a copolymer including monomer units derived from isobornyl (meth)acrylate and one or more other monomers, wherein the copolymer has a number average molecular weight (Mn) less than about 10,000 and is derived from sufficient isobornyl (meth)acrylate so that a 60 wt. % solution of the copolymer in propylene glycol monomethyl ether acetate forms a clear solution when combined at room temperature with at least three times the copolymer weight of odorless mineral spirits.

The invention provides, in yet another aspect, a method for manufacturing a coating composition, comprising the step of combining a carrier liquid, a binder resin, and a pigment vehicle, where the pigment vehicle comprises a plurality of pigment particles and the above-mentioned pigment dispersion resin. In an embodiment, the disclosed method comprises using a single such pigment vehicle to manufacture a variety of coating compositions including at least one coating composition comprising a film-forming binder resin and a polar nonaqueous solvent and at least one coating composition comprising a film-forming binder resin and a nonpolar solvent.

The invention provides, in yet another aspect, a method for manufacturing a pigment dispersion resin, comprising the steps of providing isobornyl (meth)acrylate and one or more other free-radically polymerizable monomers dissolved in a solvent, preferably in the presence of a chain transfer agent, and copolymerizing the monomers to form a copolymer having an Mn less than about 10,000 and derived from sufficient isobornyl (meth)acrylate so that a 60 wt. % solution of the copolymer in PM Acetate forms a clear solution when combined at room temperature with at least three times the copolymer weight of odorless mineral spirits.

In certain embodiments, the disclosed pigment dispersion resin is a copolymer including monomer units the majority by weight of which are derived from isobornyl (meth)acrylate. In additional embodiments, the disclosed pigment dispersion resin is a copolymer including monomer units derived from isobornyl (meth)acrylate and one or more of methyl (meth)acrylate, butyl (meth)acrylate or styrene. In further embodiments, the disclosed pigment dispersion resin is a copolymer including monomer units derived from greater than about 55% by weight isobornyl (meth)acrylate and having an Mn less than or equal to about 3,000. In certain embodiments, the disclosed pigment dispersion resin can enable high pigment loading to provide pigment vehicles or colorants with desirable flow properties exhibiting or approaching Newtonian behavior.

### DETAILED DESCRIPTION OF THE DRAWING

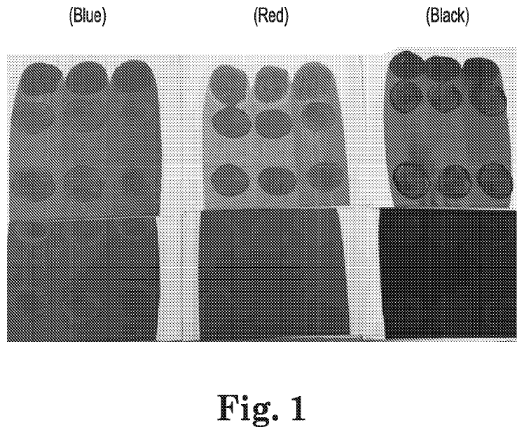

In the accompanying Drawing, FIG. 1 shows an evaluation of a pigment vehicle prepared using a commercially available pigment dispersion resin (top row) and an exemplary resin of the present invention (bottom row). FIG. 1 is adapted from color photographs and the original colors of the compositions are indicated on FIG. 1.

### DETAILED DESCRIPTION

The recitation of a numerical range using endpoints includes all numbers subsumed within that range (e.g., 1 to 5 includes 1, 1.5, 2, 2.75, 3, 3.80, 4, 5, etc.).

The terms “a,” “an,” “the,” “at least one,” and “one or more” are used interchangeably. Thus, for example, a coating composition that contains “an” additive means that the coating composition includes “one or more” additives.

The term “architectural paint” means a coating composition for use on interior or exterior building components, and includes both paints and stains.

The term “binder” means a film-forming natural or synthetic polymer suitable for use in paints and other coating composition.

The term “copolymer” means a polymer derived from two or more different monomers.

The terms “(meth)acrylate” and “(meth)acrylic” refer to acrylate and methacrylate compounds, and to acrylic and methacrylic acid, respectively.

The term “paint” means a coating composition including pigment and a film-forming binder which when applied to form a thin (e.g., 100 μm) wet thickness coating film on a freshly-sanded smooth wood surface, will dry to form a continuous film over the surface, and includes non-penetrating or other stains that will dry to form such a continuous film.

The term “pigment” means an inorganic particulate material having light-reflective characteristics and a surface energy and particle size suitable for use in paints and other coating compositions.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The term “solvent-borne” when used with respect to paints or other coating compositions means that the major liquid vehicle or carrier for such coating composition is a nonaqueous solvent or mixture of nonaqueous solvents.

The term “water-borne” when used with respect to paints and other coating compositions means that the major liquid vehicle or carrier for such coating composition is water.

The disclosed pigment dispersion resin generally contains a copolymer comprising monomer units derived from isobornyl (meth)acrylate and monomer units derived from monomers other than isobornyl (meth)acrylate. In a preferred embodiment, the monomer units derived from isobornyl (meth)acrylate are present in a majority amount by weight, and may for example be present in an amount greater than about 50%, greater than about 55%, greater than about 60%, greater than about 65%, greater than about 70%, greater than about 75%, or greater than about 80% by weight of the monomers employed to make the copolymer. In other embodiments, the monomer units derived from isobornyl (meth)acrylate may for example be present in an amount less than about 99%, less than about 95%, less than about 90%, or less than about 85% by weight of the monomers employed to make the copolymer. In some exemplary embodiments, the monomer units derived from isobornyl (meth)acrylate are present in the amount of from about 80% by weight to about 90% by weight.

Exemplary monomer units other than isobornyl (meth)acrylate that can be used to make the disclosed copolymer include free-radically polymerizable monomers such as methyl (meth)acrylate, styrene, butyl (meth)acrylate, ethyl (meth)acrylate, 2-ethyl hexyl (meth)acrylate, (meth)acrylic acid, vinyl acetate, 2-hydroxy propyl (meth)acrylate, cyclohexyl (meth)acrylate, steryl (meth)acrylate, lauryl (meth)acrylate, and alpha-methyl-styrene. The copolymer may for example include such other monomer units in a collective amount greater than about 1%, greater than about 5%, greater than about 10%, greater than about 15%, greater than about 20%, greater than about 25%, greater than about 30%, or greater than about 40% by weight of the monomers employed to make the copolymer. In some embodiments, the copolymer may for example include such other monomer units in a collective amount up to about 55%, up to about 50%, less than about 50%, or less than about 45% of the monomers employed to make the copolymer. When more than one such other monomer units are present, such other monomer units may be present in any ratio relative to one another, such as 5:95; 10:90; 15:85; 20:80; 25:75; 30:70; 35:65; 40:60; 45:65; or 50:50 when two monomers other than isobornyl (meth)acrylate are employed, or in any suitable ratio when more than two monomers other than isobornyl (meth)acrylate are employed.

Various blends of the foregoing monomers may be employed, and many copolymeric resins may be prepared consistent with the above recitation. In general, it is preferred to prepare copolymeric resins employing monomer units derived from isobornyl (meth)acrylate and other monomers suitable for providing a combination of regions within the copolymer having a polar character, such as hydrophilic groups, and regions having a non-polar character, such as alkyl or aryl groups. For example, in some exemplary embodiments, monomer units derived from methyl (meth)acrylate or butyl (meth)acrylate may be present in the resin in an amount greater than about 5% by weight, and monomer units derived from styrene may be present in the resin in an amount greater than about 25% by weight. In some exemplary embodiments, monomer units derived from isobornyl (meth)acrylate may be present in the resin in an amount greater than about 75% by weight, and monomer units derived from methyl (meth)acrylate or butyl (meth)acrylate may be present in the resin in an amount up to about 25% by weight. In some embodiments, monomer units derived from isobornyl (meth)acrylate and monomer units derived from butyl (meth)acrylate may be present in the resin in an amount greater than about 55%, greater than about 60%, greater than about 65%, greater than about 70%, greater than about 75%, or greater than about 80% by weight. In some embodiments, the copolymer may be essentially free of hydrophilic functional groups derived from monomers other than isobornyl (meth)acrylate, methyl (meth)acrylate and butyl methacrylate.

The disclosed copolymer has an Mn value less than about 10,000. In some embodiments, the copolymer has an Mn value less than about 7,000, less than about 5,000, less than about 3,000, less than about 2,500, less than about 2,000, less than about 1,500 or less than about 1,000. Number average molecular weight values may be measured using gel permeation chromatography and a polystyrene standard, and calculated using Equation I shown below:

Mn=(ΣNᵢMᵢ)/ΣNᵢ I

where Mi is the molecular weight of a polymer chain of the copolymer, and Ni is the number of chains of molecular weight Mi in the copolymer. Additionally, the disclosed copolymer may have a weight average molecular weight (Mw) value less than about 20,000. In some embodiments, the copolymer has an Mw value less than about 14,000, less than about 10,000, less than about 6,000, less than about 5,000, less than about 4,000, less than about 3,000 or less than about 2,000. Weight average molecular weight values may be measured using light scattering techniques and calculated using Equation II shown below:

Mw=(ΣNᵢMᵢ²)/(ΣNᵢMᵢ) II

where Mᵢ is the molecular weight of a polymer chain of the copolymer, and Nᵢ is the number of chains of molecular weight Mᵢ in the copolymer. In general, the odorless mineral spirits tolerance of the disclosed copolymer will tend to increase as the copolymer Mn and Mw values decrease. In addition, the viscosity and pigment dispersing ability of the disclosed copolymer will tend to decrease as the copolymer Mn and Mw values increase, with Mn values above about 10,000 and Mw values above about 20,000 being generally poorly suited for pigment dispersion. Copolymers with such higher Mn and Mw values may however be used to modify certain binder resins, for example to alter adhesion of a binder resin to chalky or other low adhesion surfaces.

The disclosed copolymers may have a variety of polydispersity values, with polydispersity being determined by dividing Mw by Mn. For example, the solubility of the disclosed copolymer in a broad range of polar and non-polar solvents may vary based in part on the polydispersity value. In some embodiments, the disclosed copolymer may have a polydispersity of at least 1.7, greater than 1.7, at least about 1.8, at least about 1.9 or at least about 2. In some embodiments, the disclosed copolymer may have a polydispersity less than about 6, less than about 5, less than about 4 or less than about 3.

As mentioned above, the disclosed copolymer is derived from sufficient isobornyl (meth)acrylate so that a 60 wt. % solution of the copolymer in PM Acetate forms a clear solution when combined at room temperature with at least three times the copolymer weight of odorless mineral spirits. In preferred embodiments, even greater amounts of odorless mineral spirits can be added to the disclosed 60 wt. % copolymer solution before a clear solution is no longer present. For example, a clear solution preferably remains even after addition of odorless mineral spirits to such 60 wt. % copolymer solution in an amount at least four times, at least five times, at least six times, at least seven times, at least eight times, at least nine times or at least ten times the copolymer weight. In an especially preferred embodiment, a clear solution will remain even when an unlimited amount (viz., any amount) of odorless mineral spirits is added to the disclosed 60 wt. % copolymer solution, and the copolymer may be said to be substantially completely soluble in odorless mineral spirits.

The disclosed resin preferably has a glass transition temperature (Tg) greater than about 25° C., more preferably greater than about 30° C. and most preferably greater than about 40° C. Tg values may be measured using differential scanning calorimetry (DSC), and may be calculated using the Fox Equation. For example, the theoretical Tg of a copolymer made from two monomer feeds may be calculated using Equation III shown below:

1/Tg=Wa/Tga+Wb/Tgb
where Tga and Tgb are the respective glass transition temperatures of homopolymers made from monomers “a” and “b”; and
Wa and Wb are the respective weight fractions of copolymers “a” and “b”.

In general, Tg may be increased by increasing the proportion of IBA (homopolymer Tg of 94° C.), IBMA (homopolymer Tg of 110° C.), or other high Tg monomers. Exemplary other such monomers include methyl methacrylate (homopolymer Tg of 105-120° C.), tert-butyl methacrylate (homopolymer Tg of 118° C.), styrene (homopolymer Tg of 100° C.), and a variety of substituted styrenes. The dirt pick-up resistance of coating compositions containing the disclosed copolymer will tend to increase as the Tg value decreases.

The invention encompasses in some embodiments a method of manufacturing the disclosed copolymer, the method generally comprising the steps of providing isobornyl (meth)acrylate and one or more other free-radically polymerizable monomers dissolved in a solvent, preferably in the presence of a chain transfer agent, and copolymerizing the monomers to form a copolymer. The provision of monomers dissolved in a solvent may encompass a process including actively dissolving monomers in a solvent or providing a previously prepared solution of monomers dissolved in a solvent. The chain transfer agent may be added to a solvent at any one or more of prior to, after, or during dissolution of monomers in the solvent. The method may further comprise addition of an initiator to the solvent at any one or more of prior to, after, or during dissolution of monomers in the solvent.

The chain transfer agent is employed to limit the molecular weight of the copolymer such that it is in the desired range. Any suitable chain transfer agent(s) may be used. For example, the chain transfer agent(s) may include any one or more of mercaptans, such as octyl mercaptan, hexyl mercaptan, 2-mercaptoethanol, n-dodecyl mercaptan, and tertiary dodecyl mercaptan. When used, the chain transfer agent may for example be employed in an amount of at least about 1% or at least about 2% by weight, and up to about 10%, up to about 7%, or up to about 5% by weight, based on the combined weight of the monomers to be copolymerized. Likewise, any suitable initiator may be used in a method of manufacturing the disclosed pigment dispersion resin. For example, an initiator may include any one or more azo compounds such as 2,2′-azobis(2-methylpropionitrile) and 2,2′-azobis(2-methylbutyronitrile); hydroperoxides such as t-butyl hydroperoxide and cumene hydroperoxide; peracetates such as t-butyl peracetate; peroxides such as benzoyl peroxide, di-tert-butyl peroxide, and methyl ethyl ketone peroxide; peroxyesters such as t-butyl perbenzoate and t-amyl perbenzoate; percarbonates such as isopropyl percarbonate; peroctoates such as t-butylperoctoate; and peroxycarbonates such as butyl isopropyl peroxy carbonate. When used, the initiator may for example be employed in an amount of at least about 1% or at least about 3% by weight, and up to about 15% or up to about 7% by weight, based on the combined weight of the monomers to be copolymerized.

The disclosed resin may be prepared by any suitable technique. The following sequence of steps may for example be employed to prepare a resin using PM Acetate solvent, isobornyl (meth)acrylate monomer, methyl (meth)acrylate monomer, n-dodecyl mercaptan chain transfer agent, and t-butylperoctoate initiator via an addition polymerization. Persons having ordinary skill in the art will understand that suitable reaction times and temperatures for carrying out the reaction in the chosen reactor vessel or other equipment should be selected and monitored using customary techniques:
1. Charge reactor with solvent and heat to a suitable temperature.
2. Mix isobornyl (meth)acrylate monomer, methyl (meth)acrylate monomer and n-dodecyl mercaptan chain transfer agent together in a feed tank and feed to reaction vessel over a chosen time period at a chosen temperature.
3. Concurrently with step 2, mix solvent and t-Butylperoctoate initiator together in an initiator tank and feed to the reaction vessel over a chosen time period at a chosen temperature.
4. Subsequently hold the batch at a reaction temperature, then reduce the temperature after a suitable time has lapsed to allow the batch to cool to a suitable lower temperature.
5. Add t-butylperoctoate booster and hold for a suitable time at the lower temperature.
6. Add booster and again hold for a suitable time at the lower temperature.
7. After holding, cool the copolymer product and add solvent to attain a desired solids content.

When used as a pigment dispersion resin, the disclosed copolymer may be provided as a solution in one or more solvents. The solvent conveniently may be the same solvent used to prepare the copolymer. In some embodiments, additional or different solvents may be employed. Any one or more known solvents suitable for use with a pigment dispersion resin, including polar and nonpolar solvents, may be employed. Such solvents may be different or the same as the solvents used to form the disclosed pigment vehicles or the disclosed coating compositions. For example, PM Acetate may be a solvent included in a pigment dispersion resin or in a pigment vehicle. Other suitable solvents include ketones such as acetone, methyl ethyl ketone, methyl propyl ketone, and methyl isobutyl ketone; glycol ethers such as propylene and ethylene glycol ethers and preferably ethylene glycol monomethyl ether, ethylene glycol monoethyl ether, and ethylene glycol monopropyl ether; acetates such as glycol ether acetates and preferably PM Acetate; aromatic hydrocarbons such as toluene, naphthalene, and xylene; specialty solvents for compliance in California and other jurisdictions such as Oxsol™ 100 parachlorobenzotrifluoride (from Isle Chem) and t-butyl acetate, aliphatic hydrocarbons such as pentane, hexane, and heptane; petroleum and wood distillates; turpentine; pine oil; mineral spirits such as odorless mineral spirits and low flash grade, regular grade, or high flash grade mineral spirits of type 0, type 1, type 2, or type 3; and the like. Exemplary pigment dispersion resins include greater than about 20%, greater than about 30%, greater than about 40%, greater than about 50%, greater than about 60%, greater than about 70%, or greater than about 80% by weight of solids or non-volatile matter. In some embodiments, the disclosed pigment dispersion resin may include from about 40% to about 70%, or from about 50% to about 60% by weight of solids or non-volatile matter.

The disclosed pigment dispersion resin has particular utility for the preparation of pigment vehicles containing the resin and a plurality of pigment particles. Without intending to be bound by theory, it is believed that generally polar, e.g., hydrophilic portions, of monomer units in the pigment dispersion resin facilitate formulation of pigment vehicles having a high concentration of pigment particles, while still permitting the pigment vehicle to have properties approaching that of a Newtonian fluid.

The disclosed pigment vehicle may include any of a variety of suitable pigment particles and pigment extenders, such as azo pigments, anazurite, aluminum silicate, aluminum potassium silicate, aluminum paste, anthraquinone pigments, antimony oxide, barium metaborate, barium sulfate, cadmium sulfide, cadmium selenide, calcium carbonate, calcium metaborate, calcium metasilicate, carbon black, chromium oxides, clay, copper oxides, copper oxychloride, dioxazine pigments, feldspar, hansa yellows azo pigments (some of which are listed above), benzimidazolones, iron oxides such as yellow and red iron oxides, isoindoline pigments, kaolinite, lithopone, magnesium silicates, metallic flakes, mica, napthol pigments such as napthol reds, nitroso pigments, nepheline syenite, perinone pigments, perylene pigments, polycyclic pigments, pyrropyrrol pigments, pthalocyanines such as copper pthalocyanine blue and copper pthalocyanine green, quinacridones such as quinacridone violets, quinophthalone pigments, silicates, sulfides, talc, titanium dioxide, ultramarine, zinc chromate, zinc oxide, and zinc phosphate. Exemplary pigment vehicles may for example include pigment and pigment dispersion resin in a weight ratio of about 0.1 to about 7, about 0.5 to about 6.0, or about 0.75 to about 5.0 pigment to pigment dispersion resin.

The disclosed pigment vehicle may also include a variety of other ingredients including any one or more pearlescents, optical brighteners, ultraviolet stabilizers, conventional dispersants, surfactants, wetting agents, synergists, and rheology modifiers. These materials are preferably dispersible or soluble in a range of solvents from non-polar solvents, such as odorless mineral spirits, to polar solvents, such as methyl ethyl ketone. Exemplary conventional dispersants include any one or more anionic dispersants, cationic dispersants, amphoteric dispersants, or nonionic dispersants that may be used in conventional pigment vehicles, including a variety of block copolymers, polyesters and acrylic dispersants that are made specificially for use in solventborne pigment dispersions. Exemplary such conventional dispersants include NUOSPERSE™ 657 and NUOSPERSE FA 196 available from Elementis Specialties, DISPERBYK™ 108 available from Altana AG, and SOLSPERSE™ M387 available from Lubrizol Corporation. Exemplary wetting agents include any one or more anionic wetting agents, cationic wetting agents, amphoteric wetting agents, or nonionic wetting agents that may be used in conventional pigment vehicles. Exemplary synergists include those suitable for use in conventional pigment vehicles, such as SOLSPERSE 5000 available from Lubrizol Corporation. Exemplary rheology modifiers include any one or more rheology modifiers that may be used in conventional pigment vehicles, such as SUSPENO™ 201-MS available from Poly-Resyn, Inc. and AEROSIL™ available from Evonik Industries. The disclosed pigment vehicle may be prepared from the disclosed pigment dispersion resin and chosen pigments via a variety of mixing techniques that will be familiar to persons having ordinary skill in the art.

An exemplary red iron oxide pigment vehicle may for example include about 15 to about 22 percent by weight of the disclosed pigment dispersion resin, about 7 to about 12% by weight PM Acetate, about 1 to about 4% by weight SOLSPERSE M387 conventional dispersant, and about 65 to about 75% by weight red iron oxide. An exemplary black pigment vehicle may for example include about 34 to about 44 percent by weight of the disclosed pigment dispersion resin, about 24 to about 34 percent by weight PM Acetate, about 0.5 to about 1.5 percent by weight NUOSPERSE FA 196 conventional dispersant, about 2.5 to about 3.5 percent by weight SOLSPERSE M387 conventional dispersant, and about 24 to about 34 percent by weight carbon black. An exemplary blue pigment vehicle may for example include about 27 to about 37 percent by weight of the disclosed pigment dispersion resin, about 25 to about 35 percent by weight PM Acetate, about 0.5 to about 1.5 percent by weight NUOSPERSE FA 196 conventional dispersant, about 4 to about 8 percent by weight SOLSPERSE M387 conventional dispersant, and about 26 to about 36 percent by weight phthalocyanine-blue pigment (PB 15:2).

The disclosed pigment vehicles may be used to prepare a variety of coating compositions. Generally, the method for preparing the coating composition comprises combining a carrier liquid, a binder resin, and a pigment vehicle, where the pigment vehicle comprises a plurality of pigment particles and the disclosed pigment dispersion resin. The coating composition generally may be a paint, although it is contemplated in some embodiments that the technology disclosed herein may be employed with other types of coating compositions, such as stains. In an embodiment, the disclosed method comprises using a single such pigment vehicle to manufacture a variety of coating compositions including at least one coating composition comprising a film-forming binder resin and a polar nonaqueous solvent and at least one coating composition comprising a film-forming binder resin and a nonpolar solvent.

The recited carrier liquid is a fluid component of a coating composition that serves to carry all of the other components of the composition, and that evaporates as a composition dries. A variety of suitable carrier liquids may be employed, including any one or more polar or non-polar solvents, including the above-described solvent(s) that may be employed to make the disclosed pigment dispersion resin or the disclosed pigment vehicle.

A variety of suitable binder resins may be used in a method of manufacturing the disclosed coating compositions. In some embodiments, the binder resin preferably includes any one or more of vinyl resins, acrylic resins, modified acrylic resins, vinyl-acrylic alkyds, styrene-acrylic alkyds, acrylic alkyds, epoxy esters, long oil alkyds, short oil alkyds, medium oil alkyds, coconut oil alkyds, phenolic modified alkyds, nitrocellulose resins, CAB resins, polyester resins, polyurethane resins or epoxy resins. The binder resin may be non-crosslinkable, crosslinkable or crosslinked. Acrylic polymers are particularly useful binder resins. Exemplary acrylic polymers are formed from monomers comprising at least one acrylic monomer, for example from at least one acrylic monomer and a vinyl aromatic hydrocarbon, such as styrene, a methyl styrene or other lower alkyl styrene, chlorostyrene, vinyl toluene, vinyl naphthalene, or divinyl benzene. Suitable acrylic monomers include a wide variety of compounds having acrylic functionality, such as alkyl (meth)acrylates, (meth)acrylic acids, aromatic derivatives of (meth)acrylic acids, acrylamides and acrylonitrile. Preferred alkyl (meth)acrylate monomers will have an alkyl ester portion containing from 1 to 12, preferably about 1 to 5, carbon atoms per molecule. Exemplary acrylic monomers include methyl (meth)acrylate, ethyl (meth)acrylate, butyl (meth)acrylate, propyl (meth)acrylate, 2-ethyl hexyl (meth)acrylate, cyclohexyl (meth)acrylate, decyl (meth)acrylate, isodecyl (meth)acrylate, benzyl (meth)acrylate, isobornyl (meth)acrylate, neopentyl (meth)acrylate and 1-adamantyl (meth)acrylate. Other suitable monomers include a variety of reaction products such as butyl, phenyl or cresyl glycidyl ethers reacted with (meth)acrylic acid; hydroxyl alkyl (meth)acrylates, such as hydroxyethyl and hydroxypropyl (meth)acrylates; amino (meth)acrylates; and acrylic acids such as (meth)acrylic acid, ethacrylic acid, alpha-chloroacrylic acid, alpha-cyanoacrylic acid, crotonic acid, beta-acryloxy propionic acid, and beta-styryl acrylic acid. Mixtures of the foregoing are contemplated.

In some embodiments of the disclosed method for manufacturing a coating composition, the binder resin may contain one or more polyester (e.g., alkyd) or epoxy binder resins. Alkyd resins and other polyesters can be prepared in a known manner by the condensation of polyhydric alcohols and polycarboxylic acids, with or without the inclusion of natural drying oil fatty acids. The polyester may contain a proportion of free hydroxyl or carboxyl groups which are available for reaction, if desired, with suitable crosslinking agents. Epoxy resins generally contain epoxies in conjunction with one or more of an aliphatic or aromatic amine curing agent, polyamide curing agent, or thiol-based curing agent. Exemplary epoxy resins include those formed from Bisphenol A or Bisphenol F, while suitable amine curing agents include aliphatic amines, phenalkamines, cycloaliphatic amines, amido amines, and polyamides. It is contemplated that the alkyd resins will often be used with mineral spirits as the carrier liquid.

Additives may be added at any suitable point during methods of manufacturing the disclosed coating compositions. Exemplary additives include any one or more of neutralizing agents, antifoaming agents, fillers, dyes, dispersants, surfactants, extenders, adhesion promoters, wetting agents, rheology modifiers, leveling agents, anti-blocking agents, mildewcides, fungicides, algaecides, bactericides, other preservatives, thickeners, thixotropic agents, drying agents, anti-settling agents, and flattening agents. When used, such additives may be present in any amounts suitable for their intended purposes. It is contemplated that some additives will play multiple roles in the disclosed coating compositions.

In general, methods for manufacturing the disclosed coating compositions may include three or more stages, including an optional pre-thin stage (which typically may be omitted when making a stain), a grind stage, a wash stage, and a thindown stage. In the pre-thin stage, one or more binder resins may be mixed with a liquid within a thindown tank, and low-shear mixing may be applied in the thindown tank to form a pre-thin mixture. The liquid added during the pre-thin stage may include any one or more of the solvents described herein in connection with the pigment dispersion resin. In the grind stage, a plurality of pigment particles and the disclosed pigment dispersion resin may be mixed in a high-shear mixing device, such as mill, to prepare a grind paste. The high shear applied in the grind stage is intended to break up agglomerates of pigment particles and to ensure the particles are wetted with the resin. A carrier liquid including any one or more of the carrier liquids described herein may also be added during the grind stage. In the wash stage, a wash liquid including any one or more of the solvents described herein in connection with the pigment dispersion resin may be pumped into the high-shear mixing device to move the grind paste into a thindown tank. In a thindown stage, the grind paste, the carrier liquid, and the wash liquid are blended together in the thindown tank under low shear conditions. These components also may be blended together with the pre-thin mixture in the thindown tank. The coating composition concentrate may be further let down through further addition of liquid including any one or more of the solvents described herein. The disclosed method of manufacturing a coating composition may employ these conventional stages, or may employ other suitable methods, such as continuous manufacturing using component slurries.

Once prepared, the disclosed coating composition may be dispensed into a storage container, such as a can or bucket. When the storage container is opened, the coating composition may be applied onto a substrate, such as wood, drywall, metal, plastic, or a composite material. Any tool suitable for applying a coating composition, such as a brush, roller, sponge, or spray gun, may be used to apply the composition. Upon application, liquid within the composition will evaporate, and the binder resin of the coating composition will form a film that upon drying or curing will yield a the desired coating.

The following examples are provided to illustrate the present invention but should not be construed as limiting its scope.

### EXAMPLES

### Example 1—Resin A-1

A 1288 g. portion of PM Acetate solvent was charged to a reaction vessel. Isobornyl methacrylate monomer (1175 g.), styrene monomer (618.5 g.), methyl methacrylate monomer (206 g.) and n-dodecyl mercaptan (85 g.) chain transfer agent were mixed together in a separate vessel to form a monomer mixture. In a third vessel, 100 g. PM Acetate solvent and 11 g. t-butylperoctoate initiator were mixed to form an initiator solution. The monomer mixture and initiator solution were concurrently added dropwise to the reaction vessel over a chosen time period and chosen temperature, followed by a small chase containing additional initiator, in order to copolymerize the monomers and form pigment dispersion Resin A-1. Resin A-1 contained 60% by weight of non-volatile matter and 40% by weight of PM Acetate. The copolymer present in Resin A-1 included 59% by weight of monomer units derived from isobornyl methacrylate, 31% by weight of monomer units derived from styrene, and 10% by weight of monomer units derived from methyl methacrylate. The copolymer in Resin A-1 had an Mn of 2,416, an Mw of 6,467, a polydispersity of 2.68 and a Gardner bubble viscosity of Y.

### Example 2—Resin A-2

Using the method of Example 1, pigment dispersion Resin A-2 was formed using an initial charge of PM Acetate solvent (1259 g.); a monomer mixture containing isobornyl methacrylate monomer (1673 g.), methyl methacrylate monomer (295 g.) and n-dodecyl mercaptan chain transfer agent (82 g.); and an initiator solution containing t-butylperoctoate initiator (46 g.) mixed in PM Acetate solvent (100 g.). Resin A-2 contained 60% by weight of non-volatile matter and 40% by weight of PM Acetate. The copolymer present in Resin A-2 included 85% by weight of monomer units derived from isobornyl methacrylate and 15% by weight of monomer units derived from methyl methacrylate. The copolymer in Resin A-2 had an Mn of 1,316, an Mw of 3,860, a polydispersity of 2.93 and a Gardner bubble viscosity of W+.

### Example 3—Resin A-3

Using the method of Example 1, pigment dispersion Resin A-3 was formed using an initial charge of PM Acetate solvent (1261 g.); a monomer mixture containing isobornyl methacrylate monomer (1675 g.), n-butyl methacrylate monomer (295 g.) and n-dodecyl mercaptan chain transfer agent (82 g.); and an initiator solution containing t-butylperoctoate initiator (47 g.) mixed in PM Acetate solvent (100 g.). Resin A-3 contained 60% by weight of non-volatile matter and 40% by weight of PM Acetate. The copolymer present in Resin A-3 included 85% by weight of monomer units derived from isobornyl methacrylate and 15% by weight of monomer units derived from n-butyl methacrylate. The copolymer in Resin A-3 had an Mn of 1,431, an Mw of 3,579, a polydispersity of 2.50 and a Gardner bubble viscosity of X—.

### Example 4—Resin A-4

Using the method of Example 1, pigment dispersion Resin A-4 was formed using an initial charge of PM Acetate solvent (1278 g); a monomer mixture containing isobornyl methacrylate monomer (1162 g.), styrene monomer (616 g.), methyl methacrylate monomer (217 g.) and n-dodecyl mercaptan chain transfer agent (84 g.); and an initiator solution containing and t-amyl peroxyethylhexanoate initiator (48 g.) mixed in PM Acetate solvent (100 g.). Resin A-4 contained 60% by weight of non-volatile matter and 40% by weight of PM Acetate. The copolymer present in Resin A-4 included 58% by weight of monomer units derived from isobornyl methacrylate, 30% by weight of monomer units derived from styrene, and 11% by weight of monomer units derived from methyl methacrylate. The copolymer in Resin A-4 had an Mn of 1,893, an Mw of 4,830, a polydispersity of 2.55 and a Gardner bubble viscosity of X—.

### Example 5—Resin A-5

Using the method of Example 1, pigment dispersion Resin A-5 was formed using an initial charge of PM Acetate solvent (1298 g.); a monomer mixture containing isobornyl methacrylate monomer (1175 g.), styrene monomer (619 g.), methyl methacrylate monomer (186 g.), glacial methacrylic acid monomer (20 g.) and n-dodecyl mercaptan chain transfer agent (85 g.); and an initiator solution containing 2,2′-azobis(2-methylbutyronitrile) initiator (12.5 g.) mixed in PM Acetate solvent (100 g.). Resin A-5 contained 60% by weight of non-volatile matter and 40% by weight of PM Acetate. The copolymer present in Resin A-5 included 59% by weight of monomer units derived from isobornyl methacrylate, 31% by weight of monomer units derived from styrene, 9% by weight of monomer units derived from methyl methacrylate and 1% by weight of monomer unites derived from methacrylic acid. The copolymer in Resin A-5 had an Mn of 2,310, an Mw of 6,483, a polydispersity of 2.81 and a Gardner bubble viscosity of Y—.

### Comparative Examples 1-4

For comparison purposes, UNICHROMA pigment dispersion resin produced by the Sherwin-Williams Company was selected for use as Comparative Example 1, LAROPAL A 81 pigment dispersion resin was selected for use as Comparative Example 2, PARALOID DM-55 pigment dispersion resin was selected for use as Comparative Example 3, and DIANAL TB-219 pigment dispersion resin was selected for use as Comparative Example 4.

### Example 6—Solubility Testing

Resins A-1 through A-5 and the resins of Comparative Examples 1 through 4 (“C. Ex. 1” to “C. Ex. 4”) were tested for solubility in a non-polar solvent by mixing a 25 g. portion of a 60% by weight solution of each resin in PM Acetate (corresponding to 15 g. resin in 10 g. of PM Acetate) with increasing amounts of odorless mineral spirits, and noting the odorless mineral spirits addition level beyond which the resulting mixture no longer formed a clear solution. The solubility test results are shown below in Table 1, expressed as the highest weight ratio of odorless mineral spirits to resin at which a clear solution remained present:

TABLE 1

| | Resin | Resin | Resin | Resin | Resin | C. | C. | C. | C. |
|---|---|---|---|---|---|---|---|---|---|
| | A-1 | A-2 | A-3 | A-4 | A-5 | Ex. 1 | Ex. 2 | Ex.3 | Ex. 4 |
| Highest weight ratio, | 5.92 | >7 | 6.79 | 6.73 | >7 | 1.38 | 1.52 | 1.62 | 2.83 |
| odorless mineral | | | | | | | | | |
| spirits to resin | | | | | | | | | |

As shown by the results in Table 1, Resins A-1 through A-5 had considerably better (viz., at least two times better) solubility in odorless mineral spirits than the commercially available pigment dispersion resins of Comparative Example 1 through Comparative Example 4. Resins A-1 through A-5 consequently should provide much better dispersion of pigments in alkyd resins and other coating compositions that employ nonpolar carrier liquids.

### Example 7—Pigment Vehicle Testing

Blue, red and black experimental pigment vehicles containing Resin A-2 and blue, red and black commercial pigment vehicles containing PARALOID™ DM-55 resin were compared to evaluate their ability to tint a stain product containing odorless mineral spirits. The pigment vehicles contained the ingredients shown below in Table 2:

TABLE 2

| Experimental | | Commercial | |
|---|---|---|---|
| Pigment Vehicle | | Pigment Vehicle | |
| Ingredient | Wt. % | Ingredient | Wt. % |
| Resin A-2 | 32 | DM-5 Resin | 31 |
| PM Acetate | 41 | PM Acetate | 34 |
| Dispersant | 3 | Dispersant | 15 |
| Pigment | 21 | Pigment | 20 |

Small portions, each amounting to about 1/20^{th} of the container contents, were poured from a 3.79 liter (one gallon) container of SUPERDECK™ semitransparent stain (from The Sherwin-Williams Company) into 0.23 liter (half-pint) cans. To each such can was added 0.03 liters (0.1 fluid oz.) of the blue, red or black experimental pigment vehicle or the blue, red or black commercial pigment vehicle shown above in Table 2. Doing so generally replicated steps that might be taken when carrying out point-of-sale stain tinting at a retail location, or (on a small scale) the factory shading of a coating composition when making standard premixed stain colors. The cans were shaken for one minute, opened to pour off about 30 ml of fluid, and closed and shaken for another two minutes. After pouring off another 30 ml of fluid, the cans were closed and shaken for twelve additional minutes. Using each color and each pigment vehicle, the first and second withdrawn 30 ml samples, and a final sample drawn from the fully shaken can, were applied side-by-side-by-side to white bond paper and drawn down with a #42 wire-round rod. After waiting until the surface no longer appeared wet, a gloved finger was used to contact the painted surfaces and circular motions were made for 5-10 seconds in a clockwise direction and 5-10 seconds in a counterclockwise direction at the top and bottom of each drawdown stripe. The coated stripes were then allowed to dry fully. The results are shown in FIG. 1.

The stripes tinted using the commercial pigment vehicle (DM-55 resin) are shown in the top row of FIG. 1, with the blue, red and black-tinted samples appearing from left to right, and the stripes after one minute, an additional two minutes and an additional 12 minutes of shaking appearing on each coated paper sheet. The stripes exhibited substantial rub-up after all three shaking intervals and for all three pigments, indicating that the commercial pigment vehicle was not adequately dissolved by odorless mineral spirits. The thus-tinted stains would not be satisfactory to potential customers.

Corresponding stripes tinted using the experimental pigment vehicle are shown in the bottom row of FIG. 1. They exhibited much better pigment vehicle compatibility with little evidence of rub-up, essentially no gritting and substantially complete solubility of the pigment vehicle in odorless mineral spirits.

Having thus described preferred embodiments of the present invention, those of skill in the art will readily appreciate that the teachings found herein may be applied to yet other embodiments within the scope of the claims hereto attached. The complete disclosure of all listed patents, patent documents and publications (including material safety data sheets, technical data sheets and product brochures for the raw materials and ingredients used in the Examples) are incorporated herein by reference as if individually incorporated. All methods described herein can be performed in any suitable order unless otherwise indicated herein or otherwise clearly contradicted by context. The use of any and all examples, or language describing an example (e.g., “such as”) provided herein, is intended to illuminate the invention and does not pose a limitation on the scope of the invention. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statement herein as to the nature or benefits of the invention or of the preferred embodiments, and any statements herein that certain features constitute a component of the claimed invention, are not intended to be limiting unless reflected in the appended claims. Neither the marking of the patent number on any product nor the identification of the patent number in connection with any service should be deemed a representation that all embodiments described herein are incorporated into such product or service.

1. A pigment dispersion resin comprising a copolymer including monomer units derived from isobornyl (meth)acrylate and one or more other monomers, wherein the copolymer has a number average molecular weight (Mn) less than about 10,000 and is derived from sufficient isobornyl (meth)acrylate so that a 60 wt. % solution of the copolymer in propylene glycol monomethyl ether acetate forms a clear solution when combined at room temperature with at least three times the copolymer weight of odorless mineral spirits.

2-23. (canceled)

24. A pigment dispersion resin according to claim 1, wherein the copolymer includes monomer units derived from greater than about 55% by weight isobornyl (meth)acrylate and has an Mn less than or equal to about 3,000.

25. A pigment dispersion resin according to claim 1, wherein the copolymer includes monomer units derived from isobornyl (meth)acrylate in an amount greater than about 70% by weight.

26. A pigment dispersion resin according to claim 1, wherein the copolymer includes monomer units derived from isobornyl (meth)acrylate in an amount greater than about 75% by weight.

27. A pigment dispersion resin according to claim 26, wherein the copolymer includes monomer units derived from methyl (meth)acrylate in an amount greater than about 20% by weight.

28. A pigment dispersion resin according to claim 1, wherein the copolymer includes monomer units derived from methyl (meth)acrylate in an amount greater than about 5% by weight, and monomer units derived from styrene in an amount greater than about 25% by weight.

29. A pigment dispersion resin according to claim 1, wherein the copolymer is essentially free of hydrophilic functional groups derived from monomers other than isobornyl (meth)acrylate and methyl (meth)acrylate.

30. A pigment dispersion resin according to claim 1, wherein the clear solution remains even after addition of odorless mineral spirits to such 60 wt. % copolymer solution in an amount at least four times the copolymer weight.

31. A pigment dispersion resin according to claim 1, wherein the clear solution remains even after addition of odorless mineral spirits to such 60 wt. % copolymer solution in an amount at least six times the copolymer weight.

32. A pigment dispersion resin according to claim 1, wherein the copolymer is substantially completely soluble in odorless mineral spirits.

33. A pigment dispersion resin according to claim 1, wherein the copolymer is substantially completely soluble in ketone, acetate, and aromatic solvents.

34. A pigment dispersion resin according to claim 1, wherein the copolymer enables high pigment loading that provides pigment vehicles or colorants with desirable flow properties exhibiting or approaching Newtonian behavior.

35. A pigment dispersion resin according to claim 1, wherein the copolymer has a polydispersity of at least about 1.8.

36. A pigment dispersion resin according to claim 1, wherein the copolymer has a polydispersity of at least about 2.

37. A pigment dispersion resin according to claim 1, wherein the copolymer has a glass transition temperature greater than 25° C.

38. A pigment dispersion resin according to claim 1, wherein the copolymer has a glass transition temperature greater than 40° C.

39. A pigment dispersion resin according to claim 1, further comprising a dispersion of one or more pigments in a pigment vehicle for in-plant use or a colorant for point-of-sale use comprising the pigment dispersion resin, the one or more pigments and an optional polar or nonpolar nonaqueous solvent.

40. A pigment dispersion resin according to claim 1, further comprising a dispersion of one or more pigments in a coating composition comprising a solution or dispersion containing the pigment dispersion resin, the one or more pigments, a film-forming binder resin and a polar or nonpolar nonaqueous solvent.

41. A pigment dispersion resin according to claim 1, further comprising a point of sale system comprising a plurality of base coating compositions and a compatible array of colorants, the coating compositions including at least one coating composition comprising a film-forming binder resin and a polar nonaqueous solvent and at least one coating composition comprising a film-forming binder resin and a nonpolar solvent, and the array of colorants including at least white, black, red, blue and green colorants containing pigment, the pigment dispersion resin and an optional polar or nonpolar nonaqueous solvent.

42. A method for manufacturing a pigment dispersion resin, comprising the steps of providing isobornyl (meth)acrylate and one or more other free-radically polymerizable monomers dissolved in a solvent, preferably in the presence of a chain transfer agent, and copolymerizing the monomers to form a copolymer having an Mn less than about 10,000 and derived from sufficient isobornyl (meth)acrylate so that a 60 wt. % solution of the copolymer in propylene glycol monomethyl ether acetate forms a clear solution when combined at room temperature with at least three times the copolymer weight of odorless mineral spirits.
